(19) United States
(12) Patent Application Publication
(10) Pub. No.: US 2018/0194170 A1
(43) Pub. Date: Jul. 12, 2018

(54) TIRE COMPRISING ELASTOMERIC MIXTURES WITH A LOW LEVEL OF SULFUR

(71) Applicant: COMPAGNIE GENERALE DES ETABLISSEMENTS MICHELIN, Clermont-Ferrand (FR)

(72) Inventors: Jacques BABAUD, Clermont-Ferrand Cedex 9 (FR); Orel FOURNIER, Clermont-Ferrand Cedex 9 (FR); Didier VASSEUR, Clermont-Ferrand Cedex 9 (FR); Delphine NAYRAT, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 15/741,653

(22) PCT Filed: Jul. 6, 2016
(86) PCT No.: PCT/EP2016/065903

§ 371 Date: Jan. 3, 2018

(30) Foreign Application Priority Data
Jul. 10, 2015 (FR) 1556553

(51) Int. Cl. B60C 9/18; B60C 1/00; B60C 9/20; C08C 19/28; C08C 19/04

(52) U.S. Cl. CPC B60C 9/185; B60C 1/00; B60C 9/2006; B60C 2200/06; C08C 19/04; B60C 2001/0066; B60C 2001/0075; C08C 19/28

(57) ABSTRACT

The tire has a radial carcass reinforcement and a crown reinforcement containing at least two working crown layers of reinforcing elements. The working crown layers are covered radially with a tread that is joined to two beads via two sidewalls. The relative density of sulfur bridges measured according to the equilibrium swelling method is less than 5% in at least 30% of the elastomer compounds present in the surface of at least one zone S in a meridian plane. The elastomer compounds are compositions based on at least one diene elastomer selected from the group of diene elastomers consisting of polybutadienes (abbreviated to “BRs”), synthetic polyisoprenes (IRs), natural rubber (NR), isoprene copolymers, butadiene copolymers with the exception of butadiene-nitrile copolymers (NBRs), apart from diene elastomers bearing carboxyl functions, and mixtures of these diene elastomers.

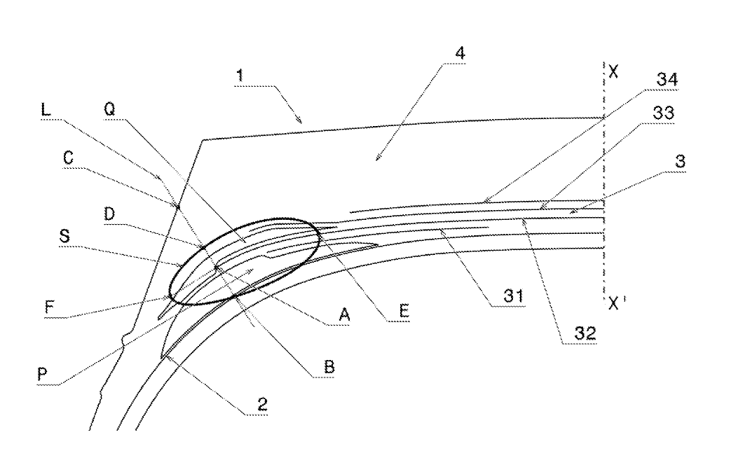

### CROSS-REFERENCE TO RELATED APPLICATION

The present application claims priority to PCT International Patent Application Serial No. PCT/EP2016/065903, filed Jul. 6, 2016 entitled “TYRE COMPRISING ELASTOMERIC MIXTURES WITH A LOW LEVEL OF SULFUR,” which claims the benefit of FR Patent Application Serial No. 1556553, filed Jul. 10, 2015.

### BACKGROUND OF THE INVENTION

### 1. Field of the Invention

The present disclosure relates to a tire with a radial carcass reinforcement, and more particularly to a tire intended to equip vehicles that carry heavy loads and run at sustained speed, such as lorries, tractors, trailers or buses, for example.

### 2. Related Art

In the tires of heavy duty type, the carcass reinforcement is generally anchored on either side in the area of the bead and is surmounted radially by a crown reinforcement made up of at least two layers that are superimposed and formed of threads or cords which are parallel in each layer and crossed from one layer to the next, forming angles of between 10° and 45° with the circumferential direction. The working layers that form the working reinforcement may furthermore be covered with at least one layer, referred to as a protective layer, formed of reinforcing elements which are advantageously metallic and extensible and referred to as elastic reinforcing elements. It may also comprise a layer of metal threads or cords having low extensibility, forming an angle of between 45° and 90° with the circumferential direction, this ply, referred to as the triangulation ply, being located radially between the carcass reinforcement and the first crown ply, referred to as the working ply, which are formed of parallel threads or cords lying at angles not exceeding 45° in terms of absolute value. The triangulation ply forms a triangulated reinforcement with at least the working ply, this reinforcement having little deformation under the various stresses to which it is subjected, the triangulation ply essentially serving to absorb the transverse compressive forces which is the role of all the reinforcing elements in the crown area of the tire.

In the case of tires for “heavy duty” vehicles, just one protective layer is usually present and its protective elements are, in the majority of cases, oriented in the same direction and with the same angle in terms of absolute value as those of the reinforcing elements of the radially outermost and therefore radially adjacent working layer. In the case of construction plant tires intended for running on more or less uneven ground, the presence of two protective layers is advantageous, the reinforcing elements being crossed from one layer to the next and the reinforcing elements of the radially inner protective layer being crossed with the inextensible reinforcing elements of the radially outer working layer adjacent to the radially inner protective layer.

Cords are said to be inextensible when the cords exhibit, under a tensile force equal to 10% of the breaking force, a relative elongation at most equal to 0.2%.

Cords are said to be elastic when the cords exhibit, under a tensile force equal to the breaking load, a relative elongation at least equal to 3% with a maximum tangent modulus of less than 150 GPa.

The circumferential direction of the tire, or longitudinal direction, is the direction that corresponds to the periphery of the tire and is defined by the direction in which the tire runs.

The axis of rotation of the tire is the axis about which it turns in normal use.

A radial or meridian plane is a plane which contains the axis of rotation of the tire.

The circumferential median plane, or equatorial plane, is a plane perpendicular to the axis of rotation of the tire and which divides the tire into two halves.

The transverse or axial direction of the tire is parallel to the axis of rotation of the tire. An axial distance is measured in the axial direction. The expression “axially inside of, respectively axially outside of” means “the axial distance of which, measured from the equatorial plane, is shorter than, respectively longer than”.

The radial direction is a direction that intersects the axis of rotation of the tire and is perpendicular thereto. A radial distance is measured along the radial direction. The expression “radially inside of, respectively radially outside of” means “the radial distance of which, measured from the axis of rotation of the tire, is shorter than, respectively longer than”.

Some current tires, referred to as “road” tires, are intended to run at high speed and over increasingly long journeys, as a result of the improvement in the road network and of the growth of the motorway network throughout the world. The combined conditions under which such a tire is called upon to run without any doubt make possible an increase in the number of kilometers traveled, the wear on the tire being reduced, but on the other hand the endurance of the tire and in particular of the elastomer compounds is detrimentally affected.

This is because there are stresses in the crown reinforcement and, more particularly, shear stresses between the crown layers, combined with a significant rise in the operating temperature at the ends of the working crown layers which result in the appearance and propagation of cracks in the rubber at the ends.

In order to improve the endurance of the crown reinforcement of the type of tire under consideration, solutions relating to the structure and quality of the layers and/or the profiled elements of rubber compounds which are placed between and/or around the ends of plies and, more particularly, the ends of the axially shortest ply have already been applied.

Patent FR 1 389 428, in order to improve the resistance to degradation of the rubber compounds situated near the crown reinforcement edges, recommends the use, in combination with a low-hysteresis tread, of a rubber profiled element covering at least the sides and the marginal edges of the crown reinforcement and made up of a low-hysteresis rubber compound.

Patent FR 2 222 232, in order to avoid separations between crown reinforcement plies, teaches the coating of the reinforcement ends in a cushion of rubber of Shore A hardness different from that of the tread surmounting the reinforcement, and higher than the Shore A hardness of the profiled element of rubber compound placed between the edges of crown reinforcement and carcass reinforcement plies.

French application FR 2 728 510 proposes arranging, on the one hand, between the carcass reinforcement and the crown reinforcement working ply radially closest to the axis of rotation an axially continuous ply formed of inextensible metal cords forming with the circumferential direction an angle at least equal to 60°, and of which the axial width is at least equal to the axial width of the shortest working crown ply and, on the other hand, between the two working crown plies an additional ply formed of metallic elements oriented substantially parallel to the circumferential direction.

French application WO 99/24269 also proposes, on each side of the equatorial plane and in the intermediate axial continuation of the additional ply of reinforcing elements that are substantially parallel to the circumferential direction, that the two working crown plies formed of reinforcing elements crossed from one ply to the next be coupled over a certain axial distance and then decoupled by profiled elements of rubber compound at least over the remainder of the width common to the two working plies.

### SUMMARY OF THE INVENTION AND ADVANTAGES

The inventors have nonetheless set themselves the task of further improving the endurance properties of the tire, in particular when the usage thereof leads in particular to increases in temperature which are detrimental to the constituent elastomer compounds of the tire, in particular in the end regions of the working layers.

This objective has been achieved according to the disclosure by a tire having a radial carcass reinforcement which includes at least one layer of reinforcing elements, the tire comprising a crown reinforcement containing at least two working crown layers of reinforcing elements, which is itself covered radially with a tread, the tread being joined to two beads via two sidewalls, the relative density of sulfur bridges measured according to the equilibrium swelling method being less than 5% in at least 30% of the elastomer compounds present in the surface of at least one zone S in a meridian plane, the at least one zone S being defined in a meridian plane by the continuous cubic spline with a curvature that passes through four points such as:
a first point B, defined by the orthogonal projection onto a reinforcing element of the carcass reinforcement of the point A forming the end of a reinforcing element of the axially widest working crown layer,
a second point D, such that the segment AD is equal to ⅓ of the segment AC, the point C being the intersection of the outer surface of the tread and of the straight line passing through the points A and B, D being borne by the straight line passing through the points A, B and C,
a third point E defined on a reinforcing element of the axially widest working crown layer such that the length of the segment AE is equal to 10% of the maximum axial width of the tire, and
a fourth point F, axially outside of the point A, such that the segment AF is perpendicular to the straight line passing through the points A, B, C and D and the length of which is equal to half of that of the segment AE, and
   the elastomer compounds present in the surface of the at least one zone S in a meridian plane being compositions based on at least one diene elastomer selected from the group of diene elastomers consisting of polybutadienes (abbreviated to “BRs”), synthetic polyisoprenes (IRs), natural rubber (NR), isoprene copolymers, butadiene copolymers with the exception of butadiene-nitrile copolymers (NBRs), apart from diene elastomers bearing carboxyl functions, and mixtures of these diene elastomers.

Within the meaning of the disclosure, the diene elastomer of the composition in accordance with the disclosure is selected from the group of diene elastomers consisting of polybutadienes (abbreviated to “BRs”), synthetic polyisoprenes (IRs), natural rubber (NR), isoprene copolymers, butadiene copolymers with the exception of butadiene-nitrile copolymers (NBRs), and mixtures of these elastomers. Such copolymers are preferentially selected from the group consisting of butadiene-stirene copolymers (SBRs), isoprene-butadiene copolymers (BIRs), isoprene-stirene copolymers (SIRs) and isoprene-butadiene-stirene copolymers (SBIRs). Diene elastomers are understood to mean modified or unmodified diene elastomers. If they are modified, they may be coupled and/or star branched or else functionalized, at the chain end or along the chain with the exception of the elastomers bearing carboxyl functions.

Within the meaning of the disclosure, the relative density of sulfur bridges is the density of sulfur bridges measured according to the equilibrium swelling method relative to the overall density of crosslinking bridges measured according to the equilibrium swelling method.

The maximum axial width of the tire is measured on the tire when the tire is mounted on its service rim and inflated to its nominal pressure.

According to one preferred embodiment of the disclosure, the relative density of sulfur bridges measured according to the equilibrium swelling method is less than 5% in at least 50% of the elastomer compounds present in the surface of the at least one zone S in a meridian plane.

Advantageously according to the disclosure, the point A forming the end of a reinforcing element of the axially widest working crown layer in a meridian plane is in contact with or included in the at least 30% of the elastomer compounds present in the surface of the at least one zone S.

Advantageously also according to the disclosure, the ends of each of the working crown layers in a meridian plane are in contact with or included in the at least 30% of the elastomer compounds present in the surface of the at least one zone S.

According to one advantageous variant of the disclosure, the relative density of ionic bridges measured according to the equilibrium swelling method is greater than 50% in the at least 30% of the elastomer compounds present in the surface of the at least one zone S in a meridian plane and preferably in the at least 50% of the elastomer compounds present in the surface of the at least one zone S in a meridian plane.

Within the meaning of the disclosure, the relative density of ionic bridges is the density of ionic bridges measured according to the equilibrium swelling method relative to the overall density of crosslinking bridges measured according to the equilibrium swelling method.

Preferably also, the relative density of ionic bridges measured according to the equilibrium swelling method is greater than 60% in the at least 30% of the elastomer compounds present in the surface of the at least one zone S in a meridian plane and preferably in the at least 50% of the elastomer compounds present in the surface of the at least one zone S in a meridian plane.

More preferentially still, the relative density of ionic bridges measured according to the equilibrium swelling method is greater than 70% in the at least 30% of the elastomer compounds present in the surface of the at least one zone S in a meridian plane and preferably in the at least 50% of the elastomer compounds present in the surface of the at least one zone S in a meridian plane.

Advantageously also according to the disclosure, the relative density of carbon-carbon bridges measured according to the equilibrium swelling method is less than 45% in the at least 30% of the elastomer compounds present in the surface of the at least one zone S in a meridian plane and preferably in the at least 50% of the elastomer compounds present in the surface of the at least one zone S in a meridian plane.

Within the meaning of the disclosure, the relative density of carbon-carbon bridges is the density of carbon-carbon bridges measured according to the equilibrium swelling method relative to the overall density of crosslinking bridges measured according to the equilibrium swelling method.

Preferably also, the relative density of carbon-carbon bridges measured according to the equilibrium swelling method is less than 35% in the at least 30% of the elastomer compounds present in the surface of the at least one zone S in a meridian plane and preferably in the at least 50% of the elastomer compounds present in the surface of the at least one zone S in a meridian plane.

More preferentially still, the relative density of carbon-carbon bridges measured according to the equilibrium swelling method is less than 25% in the at least 30% of the elastomer compounds present in the surface of the at least one zone S in a meridian plane and preferably in the at least 50% of the elastomer compounds present in the surface of the at least one zone S in a meridian plane.

According to the disclosure, the measurements of crosslinking densities are carried out using the equilibrium swelling method. In order to measure the crosslinking density, the compounds, prepared in the form of samples, were swollen in toluene for 72 hours. The weight of the samples was measured immediately after having drained off the excess solvent using blotting paper. The swelling of the samples and the absorption of solvent is inversely proportional to the presence, and therefore to the density, of crosslinking bridges.

The samples are then dried under vacuum until a constant weight is reached. From the difference between the two weight values measured, the overall density of crosslinking bridges is deduced.

Use is made of isopropyl mercaptan to selectively attack the polysulfide bridges and of hexanethiol to indiscriminately break the polysulfide and disulfide bridges. The samples are treated for 2 hours with isopropyl mercaptan and 48 hours with hexanethiol at 25° C.

After each of these treatments, a measurement of the density of crosslinking bridges is calculated from the weight measurements on the samples after swelling, as described above.

It is thus possible to determine the percentage of sulfur bridges of the samples with regard to the overall density of crosslinking bridges. This measurement of sulfur bridges is described in particular in the publication “RUBBER CHEMISTRY AND TECHNOLOGY, Vol. 87, No. 1, pp. 21-30 (2014)”.

In order to determine the percentage of ionic bridges, the same samples are subjected to a chemical attack by a treatment in toluene in the presence of chloroacetic acid for 120 hours. Such a treatment is described in the publication “POLYMER COMPOSITES-2011, 1513”.

Once the samples are thus treated, measurements of the density of crosslinking bridges are carried out again by a swelling of the compounds in toluene for 72 hours. The weight of the samples is measured as above immediately after having drained off the excess solvent using blotting paper, then after drying to constant weight. The carbon-carbon bridges constitute the unattacked residual network.

The percentage of ionic bridges is furthermore deduced therefrom by the difference between the values obtained previously.

The tests carried out with tires thus produced in accordance with the disclosure have shown that the tires have improved performances in terms of endurance especially during running that leads to high temperature rises of the elastomer compounds present in the end regions of the working layers.

The inventors consider that they have been able to demonstrate that the relative density of sulfur bridges of less than 5% in at least one portion of the zone S, as defined according to the disclosure, makes it possible to reduce the sensitivity of the tires to the effects of ageing that are in particular due to temperature rises. Specifically, the inventors are inclined to interpret these results by choices of elastomer compounds in precisely defined zones that impart a better resistance to ageing that is in particular due to temperature rises.

According to one advantageous embodiment of the disclosure, an elastomer compound having a relative density of sulfur bridges measured according to the equilibrium swelling method of less than 5% is a composition based on at least one diene elastomer, a zinc diacrylate derivative in the form of a zinc salt of formula (I)

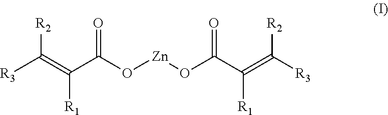

in which R1, R2 and R3 independently represent a hydrogen atom or a C1-C7 hydrocarbon-based group selected from linear, branched or cyclic alkyl groups, aralkyl groups, alkylaryl groups and aryl groups and optionally interrupted by one or more heteroatoms, it being possible for R2 and R3 to together form a nonaromatic ring, the composition additionally comprising a peroxide, the zinc diacrylate derivative and peroxide contents being such that the ratio of the peroxide content to the zinc diacrylate derivative content is less than or equal to 0.09.

Advantageously also, the composition comprises no reinforcing filler or comprises less than 65 phr thereof, the ratio of the filler content to the zinc diacrylate derivative content being less than or equal to 4.

The inventors have also demonstrated that the tires produced in accordance with these advantageous embodiments of the disclosure, according to which the content of reinforcing filler is reduced compared to more customary embodiments for the elastomer compounds in question, have improved performance levels in terms of rolling resistance. Specifically, the presence of elastomer compounds comprising a low filler content results in reduced hysteresis values compared to those of more customary compounds.

Preferentially, the disclosure relates to a composition as defined above in which R1, R2 and R3 independently represent a hydrogen atom or a methyl group. More preferentially, R2 and R3 each represent a hydrogen atom. More preferentially also, R1 represents a methyl group.

Preferably, the disclosure relates to a composition as defined above in which the amount of zinc diacrylate derivative in the composition is within a range extending from 5 to 40 phr (parts by weight per hundred parts by weight of elastomer), preferably from 7 to 35 phr.

Preferentially, the disclosure relates to a composition as defined above in which the peroxide is an organic peroxide, preferentially present in an amount of less than or equal to 3 phr. More preferentially, the amount of peroxide in the composition is within a range extending from 0.1 to 3 phr, more preferentially from 0.2 to 2.5 phr, and more preferentially still from 0.25 to 1.8 phr.

Preferentially, the disclosure relates to a composition as defined above in which the ratio of the peroxide content to the zinc diacrylate derivative content is between 0.01 and 0.09, preferably between 0.03 and 0.09 and more preferentially between 0.05 and 0.08.

It is recalled here that elastomer (or “rubber”, the two terms being regarded as synonymous) of the “diene” type should be understood, in a known way, as meaning an (one or more is understood) elastomer resulting at least in part (i.e., a homopolymer or a copolymer) from diene monomers (monomers bearing two conjugated or non-conjugated carbon-carbon double bonds).

Preferentially, the disclosure relates to a composition as defined above in which the content of reinforcing filler is within a range extending from 5 to 60 phr, more preferentially from 10 to 50 phr, better still from 20 to 40 phr.

Preferably, the disclosure relates to a composition as defined above in which the reinforcing filler is carbon black, silica or a mixture of the latter. Preferentially, the reinforcing filler predominantly consists of carbon black.

Preferentially, the disclosure relates to a composition as defined above in which the ratio of the filler content to the zinc diacrylate derivative content is within a range extending from 0.15 to 3, preferably from 1.5 to 3, alternatively and preferentially also from 0.7 to 1.3.

Preferably, the disclosure relates to a composition as defined above that contains no molecular sulfur or sulfur donor as vulcanization agent or contains less than 0.5 phr thereof. Preferentially, the composition contains no molecular sulfur or sulfur donor as vulcanization agent or contains less than 0.3 phr and preferably less than 0.1 phr thereof. Preferentially, the composition contains no vulcanization accelerator.

Preferentially, the disclosure relates to a composition as defined above that contains no antioxidant.

Preferably also, the disclosure relates to a composition as defined above additionally comprising a plasticizer preferably chosen from plasticizing resins, extender oils and mixtures thereof.

In the present application, the expression “phr” means, in a known manner, parts by weight per hundred parts by weight of elastomer. The amount by weight of the constituents of the compositions is thus expressed relative to the total amount of elastomers by weight which is considered by convention to be the value one hundred.

The expression “composition based on” should be understood as meaning a composition comprising the mixture and/or the product of the in situ reaction of the various base constituents used, some of these constituents being able to react and/or being intended to react with one another, at least partially, during the various phases of manufacture of the composition or during the subsequent curing, modifying the composition as it is prepared at the start. Thus, the compositions as employed for the disclosure can be different in the non-crosslinked state and in the crosslinked state.

In the present description, unless expressly indicated otherwise, all the percentages (%) shown are percentages by weight. Furthermore, any range of values denoted by the expression “between a and b” represents the range of values extending from more than a to less than b (that is to say, limits a and b excluded), whereas any range of values denoted by the expression “from a to b” means the range of values extending from a up to b (that is to say, including the strict limits a and b).

According to one preferred embodiment of the disclosure, the ends of the at least two working crown layers being separated by a layer Q of elastomer compound, at least one portion of the layer Q of elastomer compound forms at least one portion of the at least 30% of the elastomer compounds present in the surface of the at least one zone S in which the relative density of sulfur bridges measured according to the equilibrium swelling method is less than 5%.

Preferably also according to the disclosure, the at least two working crown layers being each formed of reinforcing elements inserted between two elastomer compound calendering layers, at least one portion of the calendering layers of the at least two working crown layers forms at least one portion of the at least 30% of the elastomer compounds present in the surface of the at least one zone S in which the relative density of sulfur bridges measured according to the equilibrium swelling method is less than 5%.

Advantageously also, at least one layer P of polymer compound being in contact with at least one working crown layer and in contact with the carcass reinforcement, the at least one layer P of polymer compound extending axially up to at least the axial end of the tread, at least one portion of the at least one layer P of elastomer compound forms at least one portion of the at least 30% of the elastomer compounds present in the surface of the at least one zone S in which the relative density of sulfur bridges measured according to the equilibrium swelling method is less than 5%.

According to the disclosure, the tire advantageously comprises two layers P, and more precisely one in each of the shoulders, positioned symmetrically with respect to one another relative to the equatorial plane. According to certain embodiment variants, a layer P continues up to the equatorial plane, the two layers P then forming only a single continuous layer from one shoulder to the other of the tire.

According to one embodiment of the disclosure, the crown reinforcement of the tire is formed of at least two working crown layers of inextensible reinforcing elements that are crossed from one layer to the other, forming angles of between 10° and 45° with the circumferential direction.

According to other embodiments of the disclosure, the crown reinforcement also comprises at least one layer of circumferential reinforcing elements.

One embodiment of the disclosure also provides for the crown reinforcement to be supplemented radially on the outside by at least one additional layer, referred to as a protective layer, of reinforcing elements, referred to as elastic reinforcing elements, that are oriented with respect to the circumferential direction at an angle of between 10° and 45° and in the same direction as the angle formed by the inextensible elements of the working layer which is radially adjacent thereto.

According to any one of the embodiments of the disclosure mentioned above, the crown reinforcement may also be supplemented, radially on the inside between the carcass reinforcement and the radially inner working layer closest to the carcass reinforcement, by a triangulation layer of metal inextensible reinforcing elements that are made of steel and form, with the circumferential direction, an angle of more than 60° and in the same direction as the angle formed by the reinforcing elements of the layer radially closest to the carcass reinforcement.

### BRIEF DESCRIPTION OF THE DRAWING

Other details and advantageous features of the disclosure will become apparent hereinafter from the description of exemplary embodiments of the disclosure, with reference to the FIGURE which depicts a meridian view of a partial diagram of a tire according to the disclosure.

### DETAILED DESCRIPTION OF THE ENABLING EMBODIMENT

In order to make them easier to understand, the FIGURE is not shown to scale. The FIGURE only depicts a half-view of a tire extending symmetrically with respect to the axis XX′ which shows the circumferential median plane, or equatorial plane, of a tire.

In the FIGURE, the tire 1, of size 295/80 R 22.5, comprises a radial carcass reinforcement 2 anchored in two beads around bead wires. The carcass reinforcement 2 is formed of a single layer of metal cords. The carcass reinforcement 2 is hooped by a crown reinforcement 3, itself capped by a tread 4.

The low zones and beads of the tire 1 are in particular not shown in the FIGURE.

In the FIGURE, the crown reinforcement 3 is formed radially from the inside to the outside:
of a triangulation layer 31 formed of non-wrapped 9.28 inextensible metal cords, oriented at an angle equal to 65°,
of a first working layer 32 formed of non-wrapped 11.35 inextensible metal cords, which are continuous over the entire width of the ply, and oriented at an angle equal to 26°,
of a second working layer 33 formed of non-wrapped 11.35 inextensible metal cords, which are continuous over the entire width of the ply, oriented at an angle equal to 18°, and crossed with the metal cords of the first working layer,
of a protective layer 34 formed of non-wrapped 6.35 elastic metal cords which are continuous over the entire width of the ply and oriented at an angle equal to 18° in the same direction as the metal cords of the working layer 33.

A zone S is defined in accordance with the disclosure by the continuous cubic spline with a curvature that passes through the points B, D, E and F in the meridian plane of the FIGURE.

The point B is defined by the orthogonal projection onto a reinforcing element of the carcass reinforcement of the point A forming the end of a reinforcing element of the axially widest working crown layer 32.

The point D is such that the segment AD is equal to ⅓ of the segment AC; the point C is the intersection of the outer surface of the tread 4 and of the straight line L passing through the points A and B, D being borne by the straight line passing through the points A, B and C.

The point E is defined on a reinforcing element of the axially widest working crown layer such that the length of the segment AE is equal to 10% of the maximum axial width of the tire, this tire being mounted on its service rim and inflated to its nominal pressure.

The point F, axially outside of the point A, is such that the segment AF is perpendicular to the straight line passing through the points A, B, C and D and such that its length is equal to half of that of the segment AE.

A layer of rubber compound Q decouples the ends of the working crown layers 32 and 33.

According to the disclosure, a layer P of rubber compound is placed between the carcass reinforcement 2 and the first working layer 32.

Various tires were produced in accordance with the disclosure with a percentage of the zone S comprising a relative density of sulfur bridges measured according to the equilibrium swelling method of less than 5% varying between 30% and 60%.

The composition used to make it possible to obtain a relative density of sulfur bridges measured according to the equilibrium swelling method of less than 5% is the following:

| | |
|---|---|
| NR (1) | 100 |
| ZDA derivative (2) | 20 |
| Peroxide (3) | 1.5 |
| Peroxide/ZDA derivative | 0.075 |
| Filler (4) | 40 |
| Filler/ZDA derivative | 2 |
| ZnO (5) | 6 |

(1) Natural rubber
(2) “DIMALINK 634” zinc dimethacrylate (ZDMA) from CRAY VALLEY
(3) “Dicup” dicumyl peroxide from Hercules
(4) N326 ASTM grade carbon black (Cabot)
(5) Zinc oxide (industrial grade - Umicore)

The composition described above results in a relative density of ionic bridges of the order of 80% and a relative density of carbon/carbon bridges of the order of 20%.

It turns out that the kinematics of curing the rubber compounds having a relative density of sulfur bridges measured according to the equilibrium swelling method of less than 5% are different from the more customary compounds in tire manufacture. In order to facilitate the curing of the various compounds, the inventors applied methods similar to those of retreading operations in order to allow a curing of the tread independent of the curing of the other compounds. The curing of the various zones of the tire may thus be controlled.

A first tire P1 according to the disclosure comprises a layer Q, at least the portion of the calenderings of the working layers present in the surface of the zone S and a portion of the layer P present in the surface of the zone S, the rubber compounds of which are produced with the composition described above. The surface occupied by these compounds represents 35% of the surface of the zone S.

A second tire P2 according to the disclosure comprises a layer Q, at least the portion of the calenderings of the working layers present in the surface of the zone S and the entire portion of the layer P present in the surface of the zone S, the rubber compounds of which are produced with the composition described above. The surface occupied by these compounds represents 55% of the surface of the zone S.

A tire P3, not in accordance with the disclosure, comprises only a layer Q, the rubber compounds of which are produced with the composition described above. The surface occupied by the layer Q represents 20% of the surface of the zone S.

A reference tire is produced, comprising no rubber compound in the zone S having a relative density of sulfur bridges measured according to the equilibrium swelling method of less than 5%.

Running tests were carried out with these four tires to evaluate the performances thereof in terms of endurance.

These endurance tests were carried out on a 40 meter development internal rolling road test machine, forcing each of the tires to run in a straight line at a speed equal to the maximum speed index prescribed for the tire under an initial load corresponding to the load prescribed by ETRTO and gradually increased, the tire being maintained at a pressure set at 20% above that recommended by ETRTO.

The distance traveled is measured until the tire exhibits a degradation of its crown. The measurements illustrated below are referenced to a base 100 for the reference tire.

| | R | P1 | P2 | P3 |
|---|---|---|---|---|
| km | 100 | 125 | 140 | 100 |

These results confirm the increases in endurance obtained with elastomer compounds defined and located in accordance with the disclosure in the zones of the tire's shoulders.

1. A tire having a radial carcass reinforcement, consisting of at least one layer of reinforcing elements, said tire comprising a crown reinforcement containing at least two working crown layers of reinforcing elements, which is itself covered radially with a tread, said tread being joined to two beads via two sidewalls, wherein the relative density of sulfur bridges measured according to the equilibrium swelling method is less than 5% in at least 30% of the elastomer compounds present in the surface of at least one zone S in a meridian plane and wherein said at least one zone S is defined in a meridian plane by the continuous cubic spline with a curvature that passes through four points such as:
a first point B, defined by the orthogonal projection onto a reinforcing element of the carcass reinforcement of the point A forming the end of a reinforcing element of the axially widest working crown layer,
a second point D, such that the segment AD is equal to ⅓ of the segment AC, the point C being the intersection of the outer surface of the tread and of the straight line passing through the points A and B, D being borne by the straight line passing through the points A, B and C,
a third point E defined on a reinforcing element of the axially widest working crown layer such that the length of the segment AE is equal to 10% of the maximum axial width of the tire, and
a fourth point F, axially outside of the point A, such that the segment AF is perpendicular to the straight line passing through the points A, B, C and D and the length of which is equal to half of that of the segment AE, and
wherein said elastomer compounds present in the surface of said at least one zone S in a meridian plane are compositions based on at least one diene elastomer selected from the group of diene elastomers consisting of polybutadienes (abbreviated to “BRs”), synthetic polyisoprenes (IRs), natural rubber (NR), isoprene copolymers, butadiene copolymers with the exception of butadiene-nitrile copolymers (NBRs), apart from diene elastomers bearing carboxyl functions, and mixtures of these diene elastomers.

2. The tire according to claim 1, wherein the relative density of sulfur bridges measured according to the equilibrium swelling method is less than 5% in at least 50% of the elastomer compounds present in the surface of said at least one zone S in a meridian plane.

3. The tire according to claim 1, wherein said elastomer compounds present in the surface of said at least one zone S in a meridian plane are compositions based on at least one diene elastomer, a zinc diacrylate derivative in the form of a zinc salt of formula (I) 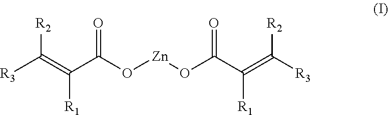
in which R1, R2 and R3 independently represent a hydrogen atom or a C1-C7 hydrocarbon-based group selected from linear, branched or cyclic alkyl groups, aralkyl groups, alkylaryl groups and aryl groups and optionally interrupted by one or more heteroatoms, it being possible for R2 and R3 to together form a nonaromatic ring, said compositions additionally comprising a peroxide, the zinc diacrylate derivative and peroxide contents being such that the ratio of the peroxide content to the zinc diacrylate derivative content is less than or equal to 0.09.

4. The tire according to claim 3, wherein the peroxide is an organic peroxide, preferentially present in an amount of less than or equal to 3 phr.

5. The tire according to claim 3, wherein the ratio of the peroxide content to the zinc diacrylate derivative content is between 0.01 and 0.09.

6. The tire according to claim 1, wherein the point A forming the end of a reinforcing element of the axially widest working crown layer in a meridian plane is in contact with or included in said at least 30% of the elastomer compounds present in the surface of said at least one zone S.

7. The tire according to claim 1, wherein the ends of each of the working crown layers in a meridian plane are in contact with or included in said at least 30% of the elastomer compounds present in the surface of said at least one zone S.

8. The tire according to claim 1, wherein the relative density of ionic bridges measured according to the equilibrium swelling method is greater than 50% in said at least 30% of the elastomer compounds present in the surface of said at least one zone S in a meridian plane and preferably in said at least 50% of the elastomer compounds present in the surface of said at least one zone S in a meridian plane.

9. The tire according to claim 1, wherein the relative density of carbon-carbon bridges measured according to the equilibrium swelling method is less than 45% in said at least 30% of the elastomer compounds present in the surface of said at least one zone S in a meridian plane and preferably in said at least 50% of the elastomer compounds present in the surface of said at least one zone S in a meridian plane.

10. The tire according to claim 1, wherein the ends of said at least two working crown layers are separated by a layer Q of elastomer compound, and wherein at least one portion of the layer Q of elastomer compound forms at least one portion of said at least 30% of the elastomer compounds present in the surface of said at least one zone S.

11. The tire according to claim 1, wherein said at least two working crown layers being each formed of reinforcing elements inserted between two elastomer compound calendering layers, and wherein at least one portion of the calendering layers of said at least two working crown layers forms at least one portion of said at least 30% of the elastomer compounds present in the surface of said at least one zone S.

12. The tire according to claim 1, wherein at least one layer P of polymer compound being in contact with at least one working crown layer and in contact with the carcass reinforcement, said at least one layer P of polymer compound extending axially up to at least the axial end of the tread, and wherein at least one portion of said at least one layer P of elastomer compound forms at least one portion of said at least 30% of the elastomer compounds present in the surface of said at least one zone S.

13. The tire according to claim 1, wherein the crown reinforcement of the tire is formed of at least two working crown layers of inextensible reinforcing elements that are crossed from one layer to the other, forming angles of between 10° and 45° with the circumferential direction.

14. The tire according to claim 1, wherein the crown reinforcement also comprises at least one layer of circumferential reinforcing elements.

15. The tire according to claim 1, wherein the crown reinforcement is supplemented radially on the outside by at least one additional ply, referred to as a protective ply, of reinforcing elements, referred to as elastic reinforcing elements, that are oriented with respect to the circumferential direction at an angle of between 10° and 45° and in the same direction as the angle formed by the inextensible elements of the working ply which is radially adjacent thereto.

16. The tire according to claim 1, wherein the crown reinforcement also comprises a triangulation layer formed of metal reinforcing elements that form angles of more than 60° with the circumferential direction.
